(19) United States
(12) Patent Application Publication
(10) Pub. No.: US 2004/0067685 A1
(43) Pub. Date: Apr. 8, 2004

(54) Panel-mount connector for an electrical cable

(75) Inventor: Leslie D. Huntsman, West Frankfurt, IL (US)

Correspondence Address: PITTS AND BRITTIAN P C, P O BOX 51295, KNOXVILLE, TN, 37950-1295, US

(73) Assignee: Special Mine Services, West Frankfurt, IL

(21) Appl. No.: 10/264,416

(22) Filed: Oct. 4, 2002

(51) Int. Cl. H01R 9/05

(52) U.S. Cl. 439/578

(57) ABSTRACT

A panel-mount electrical connector for providing an electrical connection through a wall panel or like structure and between a source electrical energy on one side of the panel and a power cable located on the opposite side if the panel including a first part comprising a central, hollow and rigid tubular electrically conductive member which is bent at an angle to define first and second leg members. Electrical terminals are provided at the opposite ends of the tubular member. The panel-mount connector is adapted to be disposed horizontally in an opening through the panel with at least a portion of the first leg and its associated terminal being disposed on the inboard side of the panel and at least a portion of the second leg and its associated terminal being disposed to project downwardly from the horizontal on the outboard side the panel. An electrically insulative covering encompasses substantially the entire length of the first part, also passing through the opening, and projecting beyond the outboard end of the first part. The outboard end of the covering of the first part is adapted to receive therein an in-line power cable second part of the connector to effect electrical connection between the first and second parts of the connector.

### FIELD OF INVENTION

The present invention relates to connectors employed to connect an electrical cable to a power source such as a portable electrical generator. In a specific embodiment, the connector functions as a panel-mount connector.

### BACKGROUND OF INVENTION

In the prior art, panel-mount connectors are employed to provide for the connection of an electrical cable, such as a stranded or solid core cable, through the panel wall of a portable electrical power generator, for example, to the interior of the generator. The known panel-mount electrical connectors are of the type wherein the panel-mount connector includes an electrically insulated elongated rigid straight electrical conductor mounted in the panel wall of a power generator. Commonly, this conductor is a solid metal rod. Thus, when the connector is mounted in the panel wall of a power generator, for example, one end of the connector projects inwardly into the interior of the generator housing and the opposite end thereof projects outwardly from the panel wall in a direction perpendicular to the plane of the panel wall and horizontal to the surface which supports the power generator. That end of the projection which projects outwardly from the panel wall may be either of the female or male variety, but in either event, is adapted to receive the end of an in-line connector attached to a cable to effect an electrical connection from the generator to the cable. When a cable is connected to the outboard end of the projection, the cable, for at least some distance, is “in-line” with the axis of the projection (i.e. the cable extends coaxially from the projection). Thus, the combination of the projecting end of the connector and the in-line portion of the cable present a safety hazard, in that personnel moving about the portable generator tend to trip over the projecting connector and cable resulting in injury to the person and/or disconnection of the cable. Often such personnel are operating under time constraints due to various circumstances and therefore are prone to overlook a projecting cable. Depending in part upon the flexibility of the cable, at some distance from the connector, commonly at least about twelve inches, the cable bends downwardly under the force of its weight and gravitation effects. In addition to the problem of personnel tripping over the extending cable, the resistance to this bending of the cable adjacent the distal end of the projection creates a bending force upon the connector at the outboard distal end thereof which tends to create separation of the end of the external cable and the outward projection of the connector, especially at the top edge of the juncture between the cable in-line connector and the panel mount connector. Particularly, this action displaces the insulative covering of the parts of the connector, forming an open gap and thereby opening up the interior of the connector to access by water, dust, moisture, etc., resulting in premature deterioration of the connector, and/or disruption of the desired electrical connection between the cable and the connector.

### SUMMARY OF INVENTION

In accordance with one aspect of the present invention, there is provided a panel-mount connector for providing an electrical connection between a power source, such as a portable electrical power generator within a housing and an electrical power cable disposed outside the housing, the connection being made through a side wall panel of the housing. The connector of the present invention includes a central, rigid and hollow tubular electrically conductive member which is bent at an angle of less than about 90 degrees, preferably about 45 degrees, and having a first terminal mounted in one of its ends and a second terminal mounted in a second and opposite one of its ends. The first end of the connector, and its associated terminal, is adapted to be disposed internally of the power generator housing, for example, and the second end and its associated terminal is adapted to be disposed externally of the power generator housing. At least the central portion of the connector is provided with an electrically insulative covering and with means for mounting the connector in the panel wall of the generator. Further, at least that end of the connector which is disposed external of the external end of the connector and its terminal, is provided with an electrically insulative covering. In use, the connector is mounted in the panel wall with the longitudinal axis of its second (external) end directed downwardly toward the surface upon which the generator housing is supported at an angle established by the angle of bend of the central conductor. A power cable which is connected to an in-line connector is connected to the external terminal of the panel-mount connector in the usual manner, but after the power cable is connected, its length adjacent the panel-mount connector extends downwardly away from the panel-mount connector and toward the supporting surface at an angle of less than 90 degrees relative to the horizontal, thereby relieving substantially all stresses between the external cable and the panel-mount connector and eliminating the tendency of the development of a separation between the power cable connect and the panel-mount connector at their juncture. Moreover, the extent to which the external end of the panel-mount connector and the power cable and its in-line connector project away from the generator is minimized, thereby minimizing the likelihood of personnel tripping over the power cable as they move about the generator.

### BRIEF DESCRIPTION OF THE FIGURES

FIG. 1 is a side elevational view, in section and exploded of a prior art male panel-mount connector and depicting a power cable attached in-line to the externally projecting end of the in-line connector;

FIG. 1A is an end view of the connector of FIG. 1;

FIG. 2 is a side elevational view, in section of a prior art female panel-mount connector and depicting a power cable attached in-line to the externally projecting end of the in-line connector;

FIG. 2B is an end view of the connector of FIG. 2;

FIG. 3 is a schematic representation of a panel-mount connector of the prior art mounted in the wall panel of a power generator housing and including a power cable connected in-line with the panel-mount connector, and also depicting a panel-mount connector of the present invention mounted in the same wall panel of the power generator housing and including a power cable connected in-line with the present panel-mount connector;

FIG. 4 is a side elevational view, in section, of a female panel-mount connector embodying various of the features of the present invention; and

FIG. 5 is a side elevational view, in section of a male panel-mount connector embodying various of the features of the present invention.

### DETAILED DESCRIPTION OF INVENTION

Herein, like elements of the depicted embodiments are identified with primed numerals. Further, the term “connector” is employed hereinafter at times to denote a “two-part” device, a first part (panel-mount connector) being adapted to be mounted in a panel or the like and provide electrical current transmission from one side of the panel to the other side of the panel, and a second part (in-line cable connector) which is wholly disposed on such other side of the panel, the two parts being releasably interconnectable in electrically conductive relationship to transfer electrical power from the first part to the second part, thence to a location remote from the connector. It will be recognized that the first and second parts of a connector alternatively may be of either a “female” or a “male” configuration as desired.

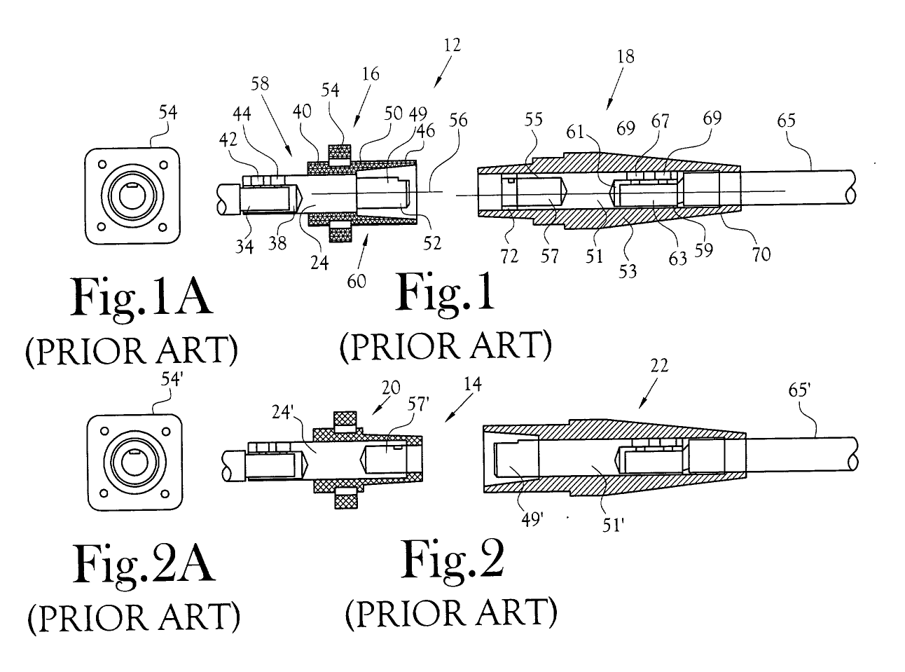

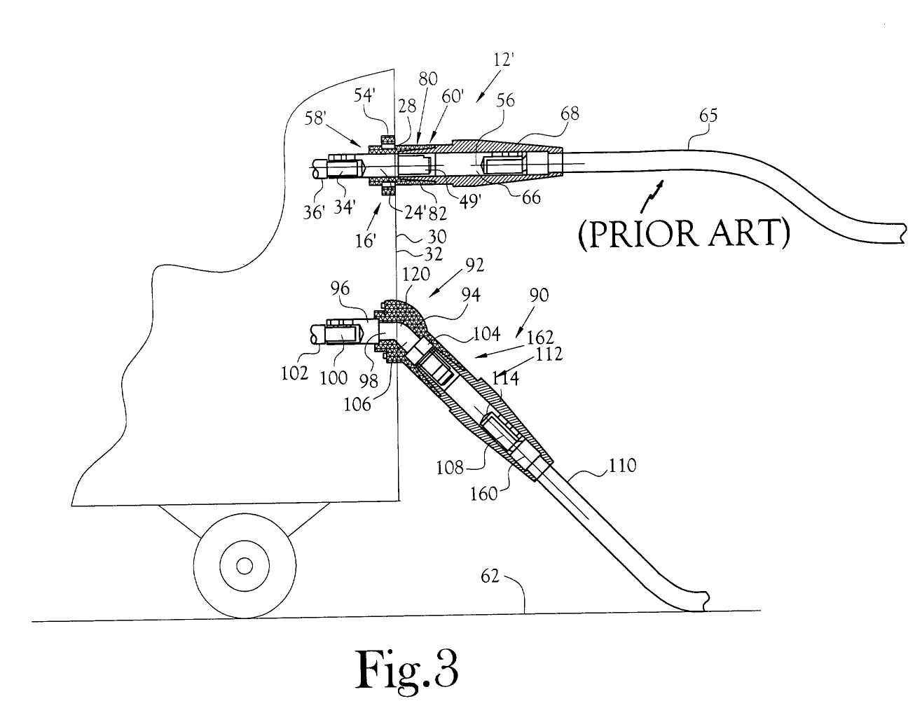

Referring initially to FIGS. 1, 2 and 3, it will be noted that the prior art panel-mount connectors 12 and 14 are of the prior art “two-part” variety. In each instance, the prior art connector is divided into a panel-mount connector 16,18 and an in-line cable connector 20,22. In the depicted connector of FIG. 1, the first part 16 of the connector comprises a single straight electrically conductive rigid metal (e.g. copper) rod 24. A first end 26 of the first part (including a portion of the copper rod) is adapted to be passed through an opening 28 through a panel, such as a side wall panel 30 of a power generator housing 32 (see FIG. 3), and to be electrically connected to the conductor 34 of a cable 36 leading to the first part 16′ from a power generator (not shown) contained within the housing 32. Referring to FIGS. 1 and 2, such electrical connection commonly comprises insertion of the cable conductor 34 into a blind bore 38 provided in the inboard end 40 of the first part 16 of the connector 12 and anchoring of the conductor 34 within the bore 38 as by set screws 42,44. A second (outboard) end 52 of the rod 24 of the first part 16 of the connector 12 is disposed externally of the generator housing and is of reduced diameter to define a male contact 49 suitable to be received within a blind bore 57 of a complementary second part (in-line cable connector) 18, hence this first part 16 of the connector depicted in FIG. 1 is deemed a male part.

The second part 18 of the depicted prior art “two-part” connector 12 likewise includes a single electrically conductive rigid metal (e.g. brass) rod 51 which also is encased within an electrically insulative covering 53. A first end 55 of the rod 51 is provided with an axially oriented blind bore 57 which defines a receptacle for the receipt therein of the male contact 49 in snug and electrically conductive relationship when the first and second parts are joined. The opposite and second end 59 of the rod 51 is likewise axially bored 61 to receive therein the conductor 63 of an external power cable 65. Retention of the conductor 63 within the bore is facilitated by means such as set screws 67,69 which are threaded through the wall of the bore 61. The power cable commonly 65 leads from its in-line connector 18 (i.e., second part of the connector 16) to a remote site for the provision of electrical power to such remote site. This second part 18 of the connector 12 is referred to as the female part. Like the first part, the electrically insulative covering of the second part of the connector extends from a location adjacent the attachment of the power cable to the inboard end 70 of the second part, along the length of the second part to terminate beyond the outboard end 72 of the rod 51 second part.

Referring to FIGS. 1 and 3, the first part 16 of the connector 12′ is provided with an electrically insulative covering 50 which extends from a location inside the housing 32 for the power generator, through the opening 28 in the side wall panel 30 of the housing, and terminates beyond the outboard end 52 of the rod 24 of the first part 16 of the connector. This covering is provided with a circumferential flange 54 (see also FIGS. 1A and 2A) which is oriented in a plane substantially perpendicular to the longitudinal centerline 56 of the first part of the connector and is adapted to mount the first part of the connector in the opening through the panel side wall of the portable electric generator housing, for example (see FIG. 3) with a first portion 58′ of the first part of the connector being disposed internally of the generator housing and the remaining portion 60′ of the second part 18 of the connector 12 being disposed externally of the generator housing. By this means, the longitudinal centerline 56 of the first part 16 of the prior art connector 12 is oriented substantially horizontal relative to a surface 62 upon which the generator is supported.

As depicted in FIG. 2, the prior art connector of FIG. 1 is convertible to a female first part 20 and male second part 22 by altering the outboard end of the metal rod 24′ of the first part to define a receptacle 57′ and altering the outboard end of the metal rod 51′ of the second part to define a male contact 49′. The only material differences between the prior art male and female versions is in the configuration of the outboard ends of the respective rigid rods of these connector parts and the geometry of their respective coverings. Either version only provides for axial and horizontal alignment of the axes of the first and second parts of the connector, hence development of the problems of the prior art connectors.

As noted, in either the male or female version of the prior art in-line connector, the first and second parts are housed within an electrically insulative material, such as rubber. Further in each of the versions, the covering extends beyond the outboard end of each of the metal rods of each part. Still further, in each instance, the outer circumferential surface of that portion of the covering which extends beyond the outboard end of the female part of the connector is tapered inwardly in a direction outboard of the female part, and that portion of the covering which extends beyond the outboard end of the male part of the connector is adapted to snugly receive therein the tapered portion of the covering associated with the female part of the connector (see FIG. 1 and 3) to effect an electrically conductive path through the connector.

In the prior art connectors, it is these fitted-together portions of the coverings which are subjected to severe stresses when the relative heavy power cable 65 is connected to the second part of the connector and extends horizontally unsupported from the second part the connector for a distance which is in part determined by the rigidity of the cable itself. This factor may be seen in the prior art connector depicted in the upper portion of FIG. 3. Commonly, a power cable 65 will extend horizontally from the second part 12′ of the prior art connector for a distance of about twelve or more inches. The resistance of the power cable to bending imposes severe stresses upon the coverings of the first and second parts of the connector at their junction 82. In particular, the insulative coverings of the first and second parts tend to either create a separation or type of crevice at their junction, especially at the top of the junction (as viewed in FIG. 3), thereby opening up the interior of the connector to ambient atmosphere, which may include moisture, water, dust, etc. As noted, the horizontal extension of the power cable 65 also presents both a safety hazard and an operational hazard in that personnel moving about the portable generator tend to trip over the horizontally extending cable and fall, and/or disengage the first and second parts of the connector resulting in loss of power at the remote location.

Referring to the lower portion of FIG. 3 and FIGS. 4-6, in accordance with one aspect of the present invention, there is provided an electrical panel-mount connector 90 suitable for mounting in a side panel wall 30 of a portable electrical generator housing 32, for example.

The depicted panel-mount connector of the present invention constitutes the first part of the connector and comprises three elements, namely; (a) a central hollow metal tube 94 (e.g. copper tube) which is centrally bent to an angle of not greater than about 90 degrees, and preferably about 45 degrees, (b) an electrically conductive first terminal 96 fixedly secured within the inboard end 98 of the tube 94 for the electrical connection thereto of the conductor 100 of a cable 102 leading to a power generator, for example, disposed within the housing 32 (see FIG. 3), and (c) an electrically conductive second terminal 104 fixedly anchored to the outboard end 106 of the tube 94 for the electrical connection therewith of a second part 112 of the connector 90. This second part 112 (in-line cable connector) includes an inboard axial bore 114 for the receipt therein of a conductor 108 of a power cable 110 leading to a location remote from the power generator.

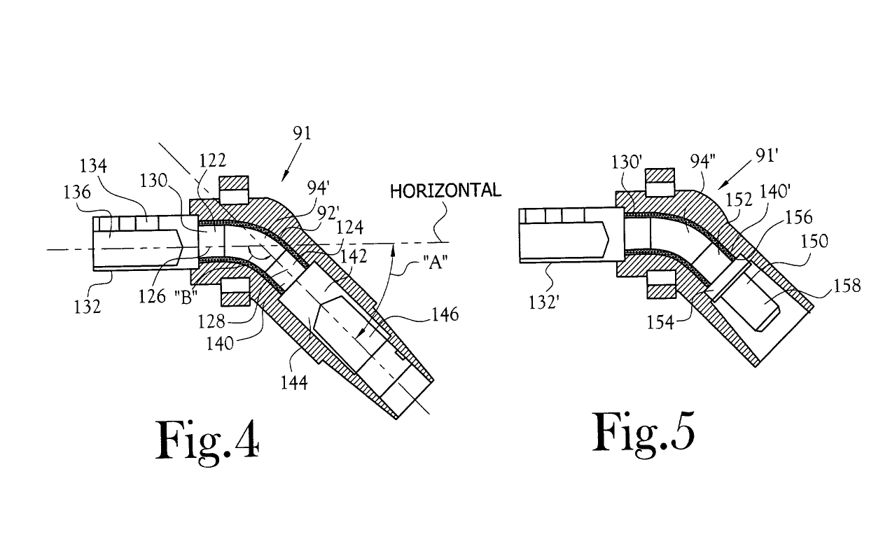

In the present invention, the first part 92 may define a male part or a female part through selection of the design of the terminals thereof and the associated outer electrically insulative coverings therefor FIG. 4 depicts a female version of the first part of a connector according to the present invention and FIG. 5 depicts a male version of the first part of a connector according to the present invention.

In accordance with the present connector, as depicted in FIG. 3, the first part 92 thereof is adapted to be mounted in an opening 120 through the side wall panel 30 of the generator housing 32. The second (outboard) and opposite end of the first part projects outwardly from the wall panel and at an angle downwardly from the horizontal to releasably connect with the second part of the connector, hence with the power cable leading from the connector to a remote site. Notably, the power cable, when connected to the connector 90, extends downwardly toward the surface upon which the generator housing is supported at an angle “A” of less than about ninety degrees with respect to the horizontal. The first and second parts are releasably connected to one another to complete the connection between the power generator and the power cable leading to a remote location and to join the mating outboard ends of their respective coverings.

Referring to FIGS. 4 (female version) and 5 (male version), in one specific embodiment of a connector of the present invention, the first part 91 of the connector 92′ includes a central hollow tubular electrical conductor 94′ having first (inboard) and second (outboard) end legs 122,124, each of which includes a respective longitudinal axis 126,128. The end legs in the depicted embodiment are of equal length, but they may be of different lengths as desired. The tubular conductor 94′ is bent such that the axes of the two end legs of the bent tube intersect at an angle “B” therebetween of greater than ninety and less than one hundred eighty degrees, preferably about one hundred thirty degrees, thereby aligning the axis of the outboard leg 124 of the bent tube downwardly from the horizontal at an angle “A” of less than about 90 degrees and preferably about 45 degrees.

The central tubular conductor 94′ may be of any suitable electrically conductive material, preferably a metal, and most preferably of copper or brass metal. In a typical embodiment, the conductor comprises a one-half inch diameter copper tube having a wall thickness of about one-sixteenth inch.

The first (inboard) end 130 of the conductor defines a first (inboard) terminal 132, which in the depicted embodiment, comprises a solid metal generally cylindrical electrically conductive fitting having a body portion 134 which is centrally bored at its distal end to define a blind bore 136 which opens outwardly of the distal end of the terminal. This bore is configured to receive therein the conductor of a cable (stranded or solid core) (see FIG. 1) which leads from a generator (not shown) disposed within a housing 32.

In the female version of the first part of the connector of the present invention as depicted in FIG. 4, the second (outboard) end 140 of the tube also defines a second terminal 142 comprising a solid metal generally cylindrical electrically conductive fitting having a body portion 144 which is centrally bored at its distal end to define a blind bore 146 which opens outwardly of the distal end of the terminal. This bore is configured to frictionally receive therein the second (male) part of the connector. (see FIG. 3).

Referring to FIG. 5, a male version of the first part 91′ of the connector of the present invention also comprises three parts including a central bent tube conductor 94″ having an inboard end 130′ and an outboard end 140′. In this male version of the first part of the connector there is provided an inboard terminal 132′ which is substantially identical in configuration and function as the inboard terminal 130 of the female version of the first part of the connector. Contrary to the female version of the first part of the connector, the outboard end 140 of the male version is provided with a terminal including a solid metal (e.g. copper), generally cylindrical, fitting 150 having a first end 152 of reduced diameter adapted to be fixedly received and anchored in the outboard end 140′ of the hollow bent tube 94″, a circumferential shoulder 154 located approximately equidistant from the opposite ends of the fitting and adapted to abut the open end 156 of the bent tube, and limit the extent of insertion of the fitting into the tube, and a lug 158 which projects outwardly from the outboard end 140′ of the bent tube and which is configured to be snugly received in electrically conductive relationship in the mating receptacle of a female fitting of a second part of the connector.

If desired, either or both of the ends of the tubular conductor 94′,94″ of either the male or female versions may be threaded internally and the reduced diameter portion of either or both of the terminals may be externally threaded to thereby be threadably mounted in their respective end of a tubular conductor.

Notably, in accordance with the present invention, and as depicted in FIG. 3, when the second part of the connector is joined to the first part of the connector that is mounted in the side wall panel of the generator housing, the power cable which is connected to the inboard terminal of the second part of the connector extends from the terminal in a straight line which is parallel to the axis 160 of the second part of the connector, but not to the axis of the inboard leg 122 of the first part of the connector. The selected angle at which the axis of the second part of the connector extends relative to the horizontal, is designated by the arrow “A” in FIG. 4. In accordance with one aspect of the present invention, this angle “A” is chosen to be less than about ninety degrees with respect to the horizontal, thereby minimizing any stresses experienced by the connector at the junction 162 of the first and second parts of the connector. Especially, by reason of the angularity at which the power 110 cable is oriented with respect to the horizontal, there is minimal if any, disorientation of the insulative coverings of the first and second parts of the connector at their junction thereby ensuring continuous protection of the interior of the connector from harmful ambient conductors.

Whereas various specific configurations and/or elements of the present invention have been disclosed for purposes of clarity and understanding of the present invention, it will be recognized by one skilled in the art that other equivalent configurations and/or elements may be employed in the present invention without departing from the scope of the present invention.

What is claimed:

1. A panel-mount electrical connector adapted to provide for the passage of electrical energy through an opening in a panel or like structure which oriented upright relative to the horizontal and includes an inboard side and an outboard side comprising
an electrically conductive hollow tubular member of generally cylindrical geometry having a longitudinal axis and first and second ends, said member being bent about its longitudinal axis at a location intermediate its first and second ends to thereby define first and second legs disposed on opposite sides of the site of said bend, each leg having a longitudinal axis,
said tubular member being adapted to be fixedly received through the opening in the panel or like structure whereby at least a portion of said first leg resides on the inboard side of the panel or like structure and at least a portion of said second leg resides on the outboard side of the panel or like structure, and said longitudinal axis of said first leg is oriented substantially horizontally, and at least a portion of said second leg resides on the outboard side of the panel and its longitudinal axis is oriented downwardly from the horizontal,
a first electrical terminal defined on said first end of said tubular member,
a second electrical terminal defined on said second end of said tubular member,
an electrically insulative covering circumferentially encasing said first part from a location along the length thereof located on the inboard side of said panel or like structure and extending therefrom to terminate beyond said second electrical terminal.

2. The electrical connector of claim 1 and including a second part including an electrically conductive elongated member having a longitudinal axis and first and second ends, said first end of said elongated member having a first terminal defined thereon, said terminal being adapted to receive a cable conductor electrically engaged therewith, and said second end of said elongated member having a second terminal adapted to releasably electrically connect to said outboard terminal of said first part,
an electrically insulative covering circumferentially encasing said second part from a location adjacent its attachment to a cable, along the length thereof and covering said first terminal of said second part, to terminate beyond said first electrical terminal of said second part,
said portions of said coverings extending beyond their respective second terminals of said first part and said second part having respective geometries adapted to releaseably interlock to define a shield against entry of ambient environment internally of the connector.

3. The electrical connector of claim 2 wherein said second part comprises an inline cable connector.

4. The electrical connector of claim 1 wherein said longitudinal axis of said outboard leg of said tubular member is oriented at an angle of less than about 90 degrees relative to the horizontal.

5. The electrical connector of claim 4 wherein said angle is about 45 degrees.
